(19) United States
(12) Patent Application Publication
(10) Pub. No.: US 2017/0028392 A1
(43) Pub. Date: Feb. 2, 2017

(54) PROCESS FOR THE PREPARATION OF A CATALYST INTENDED FOR USE IN A FISCHER-TROPSCH REACTION

(71) Applicant: IFP Energies nouvelles, Rueil-Malmaison Cedex (FR)

(72) Inventors: Fabrice DIEHL, Lyon (FR); Jean-Christophe VIGUIE, Lyon (FR)

(73) Assignee: IFP Energies nouvelles, RUEIL-MALMAISON CEDEX (FR)

(21) Appl. No.: 15/223,562

(22) Filed: Jul. 29, 2016

(30) Foreign Application Priority Data
Jul. 31, 2015 (FR) 15/57.396

(51) Int. Cl. B01J 37/18; B01J 35/10; B01J 37/12; C10G 2/00; B01J 23/75

(52) U.S. Cl. CPC B01J 37/18; C10G 2/332; B01J 23/75; B01J 37/12; B01J 35/1019; C10G 2300/703

(57) ABSTRACT

In a reactor I a catalyst support impregnated with a solution of cobalt nitrate is oxidized at a calcining temperature comprised between 400° C. and 450° C. in order to produce a catalyst precursor comprising cobalt oxides. This catalyst precursor is contacted in reduction reactor A with reducing gas rich in hydrogen and with a low water content, by circulating the flow of reducing gas, so as to reduce the cobalt oxides to Co and to produce water. Water content is reduced to 200 ppmvol of the flow of reducing gas laden with water recovered at the outlet of the reactor A, and at least a part of the flow of reducing gas is recycled to the reactor A. In the process, the reducing gas is maintained at a water content less than 10,000 ppmvol in reactor A.

The present invention relates to the field of the preparation of a catalyst, in particular the preparation of a catalyst composed of cobalt deposited on a support.

Fischer-Tropsch synthesis processes allow the catalytic conversion of synthesis gas, a mixture of carbon monoxide and hydrogen, to liquid hydrocarbons. The hydrocarbons formed are mainly alkanes and a small proportion of alkenes and oxygen-containing compounds (alcohols, ketones, etc.). The main co-product of the Fischer-Tropsch synthesis is water, which must be treated given the content of oxygen-containing compounds it contains.

The metals used in the catalysts used for the Fischer-Tropsch synthesis are commonly iron and cobalt. The catalysts with iron are used mainly for the synthesis of light fuels and of chemical compounds. The catalysts based on cobalt are used mainly for the production of synthetic fuels of the kerosene and gas oil type. In order to be catalytically active, these metals must be in reduced form, generally requiring an industrial stage prior to their utilization in the Fischer-Tropsch synthesis reactor.

Documents EP 1,239,019 and FR 2,784,096 describe different preparation methods for a cobalt-based catalyst on an alumina support for utilization in a Fischer-Tropsch process. Generally, the cobalt is deposited in the form of cobalt nitrate on the alumina support by impregnation. Then the impregnated support is calcined in order to produce a catalyst precursor.

Before utilization in the Fischer-Tropsch process, the catalyst precursor is subjected to a reduction stage. Generally, the reduction stage is carried out by bringing the catalyst precursor into contact with a flow of hydrogen in order to reduce the cobalt oxide (CO₃O₄) to metallic cobalt (Co°). The reduction reaction of cobalt oxide to metallic cobalt using hydrogen produces water. Poor elimination of this water during the reduction would lead to water spending too long in contact with the metallic catalyst, which can be detrimental to the activity of the catalyst. Documents U.S. Pat. No. 6,919,290, EP 533227 and EP 533228 propose to reduce the catalyst precursor by means of a hydrogen flow which circulates in a loop. In order to control the water content in this flow, these documents propose to use a flow composed of a low hydrogen content and a high inert gas content so as to limit the concentration of water formed in the flow of reducing gas. Furthermore, these documents propose to remove water from the reducing gas originating from the reduction stage.

The present invention proposes to improve on the prior art by using a reducing gas with a high hydrogen content and by controlling the water content during the reduction stage, in particular by carrying out calcining of the catalyst precursor at high temperature.

### PROCESS ACCORDING TO THE INVENTION

The present invention relates to a process for the preparation of a catalyst intended for utilization in a Fischer-Tropsch reaction, in which the following successive stages are carried out:
a) a support impregnated with a solution of cobalt nitrate is provided,
b) said support impregnated with a cobalt nitrate solution is oxidized at a calcining temperature comprised between 400° C. and 450° C. in order to produce a catalyst precursor comprising cobalt oxides,
c) a reducing gas is provided, comprising at least 99% by volume of hydrogen and less than 200 ppmvol of water,
d) said catalyst precursor is brought into contact with the reducing gas by circulating the flow of reducing gas over a bed of said catalyst precursor, so as to reduce the cobalt oxides to metallic cobalt in order to produce a reduced catalyst and a flow of reducing gas laden with water,
e) the water content of the flow of reducing gas laden with water recovered in stage d) is reduced, so as to produce a flow of reducing gas comprising less than 200 ppmvol of water, then
f) at least a part of the flow of reducing gas is recycled to stage d), process in which in stage d) the reducing gas is maintained at a water content of less than 10,000 ppmvol.

According to the invention, in stage d), the flow rate of reducing gas can be comprised between 1 Nm³/h/kg of catalyst precursor and 6 Nm³/h/kg of catalyst precursor and preferably between 2 Nm³/h/kg of catalyst precursor and 5 Nm³/h/kg of catalyst precursor.

Stage d) can be carried out at a pressure comprised between 0 and 1.5 MPa g, preferably between 0.3 and 1 MPa g and at a final reduction temperature comprised between 350° C. and 500° C. and preferably between 400° C. and 450° C.

Stage d) can be carried out at a final reduction temperature of less than the calcining temperature. The final reduction temperature can be less by at least 5° C., preferably at least 10° C. than the calcining temperature.

In stage d), the temperature of the reducing gas can be progressively increased according to a temperature gradient comprised between 0.5° C./min and 4° C./min, preferably between 0.5° C./min and 3° C./min, or even between 0.5° C./min and 2° C./min.

In stage b), the impregnated support can be maintained at the calcining temperature for a duration greater than 2 h, preferably comprised between 2 h and 10 h.

In stage e), the reducing gas can be cooled and water condensed by the cooling can be eliminated.

In stage e), it is also possible to bring the reducing gas into contact with at least one molecular sieve which captures the water. The molecular sieve can be regenerated by bringing the molecular sieve into contact with a portion of the flow of water-laden reducing gas recovered in stage d), said portion then being introduced with the reducing gas at the inlet of stage e).

In stage d), the catalyst precursor can be maintained at a final reduction temperature for a duration comprised between 5 hours and 24 hours.

When at least a part of the cobalt oxides are reduced to metallic cobalt, the reduced catalyst can be removed from stage d).

The support can be a porous support having a specific surface area comprised between 100 m²/g and 500 m²/g, preferably between 150 m²/g and 300 m²/g and a pore volume measured by mercury porosimetry comprised between 0.4 ml/g and 1.2 ml/g.

The support can be selected from the supports constituted of alumina, a mixture of silica and alumina, silica, titanium oxide, zinc oxide.

The present invention also relates to a catalyst prepared according to the process for the preparation of a catalyst according to the invention.

The present invention also relates to a process for the production of hydrocarbon compounds, in which the catalyst according to the invention or the catalyst prepared according to the process for the preparation of a catalyst according to the invention is brought into contact with a gaseous mixture of hydrogen and carbon monoxide.

### BRIEF DESCRIPTION OF DRAWINGS

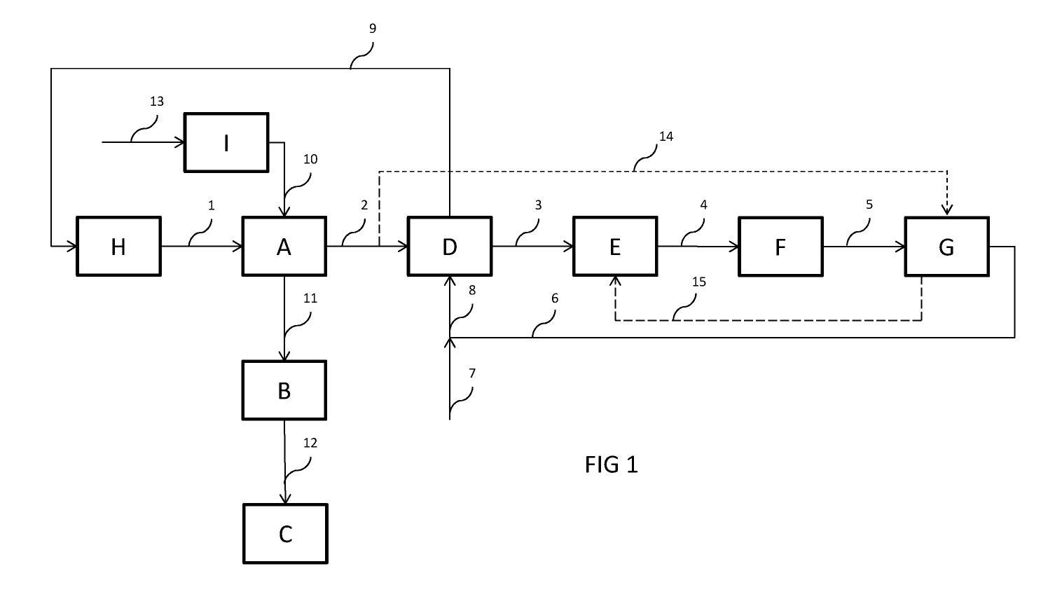

Other characteristics and advantages of the invention will become apparent on reading the following description of non-limitative embodiments, with reference to FIG. 1 which shows diagrammatically an embodiment of the process according to the invention.

### DETAILED DESCRIPTION OF THE INVENTION

The process shown diagrammatically in FIG. 1 allows the preparation of a batch of catalyst precursor in order to produce a catalyst intended for utilization in a Fischer Tropsch process.

The invention proposes to use a support impregnated with cobalt.

The support can be selected from the supports constituted of alumina, a mixture of silica and alumina, silica (SiO₂), titanium oxide (TiO₂) zinc oxide (ZnO). Preferably, the support is constituted of a mixture of silicon oxide and alumina. Preferably, the support is a porous support having a specific surface area comprised between 100 m²/g and 500 m²/g, preferably between 150 m²/g and 300 m²/g and a pore volume measured by mercury porosimetry comprised between 0.4 ml/g and 1.2 ml/g. Generally, the support is in the form of grains having dimensions comprised between 10 and 500 μm, preferably between 30 and 200 μm.

The texture and structure properties of the described support and catalyst are determined by the characterization methods known to a person skilled in the art. The total pore volume and the pore distribution are determined in the present invention by mercury porosimetry (cf. Rouquerol F.; Rouquerol J.; Singh K. “Adsorption by Powders & Porous Solids: Principle, methodology and applications”, Academic Press, 1999). More particularly, the total pore volume is measured by mercury porosimetry according to standard ASTM D4284-92 with a wetting angle of 140°, for example by means of a device of the model Autopore III™ trade mark Micromeritics™. The specific surface area is determined in the present invention by the B.E.T method, described in the same reference work as the mercury porosimetry, and more particularly according to standard ASTM D3663-03.

The catalyst support can be impregnated with one or more dopants, for example a compound selected from the following list: magnesium (Mg), copper (Cu), cobalt (Co), nickel (Ni), tin (Sn), zinc (Zn), phosphorus (P), boron (B), lithium (Li), calcium (Ca), caesium (Cs), sodium (Na), potassium (K), iron (Fe) and manganese (Mn).

The support, doped or not, is impregnated with an active phase composed of cobalt, the function of which is to catalyze the Fischer-Tropsch reaction. The cobalt can be impregnated on the support in the form of cobalt salt, for example cobalt nitrate, cobalt acetate, cobalt oxalate, by the technique of impregnation in excess or of dry impregnation. It is possible to impregnate, in one or more stages, a quantity of cobalt comprised between 1% and 30% by weight with respect to the weight of the catalyst in oxide form and preferably between 2% and 15% with respect to the weight of the catalyst in oxide form. Preferably, the cobalt content represents from 1 to 60% by weight, preferably from 5 to 30% by weight, and very preferably from 10 à 30% by weight with respect to the weight of the catalyst in oxide form. In order to determine the cobalt content, the oxide form corresponds to the form Co₃O₄ and the cobalt content in %, is calculated as mass Co₃O₄/(mass Co₃O₄+mass of the support).

The support impregnated with cobalt can be produced according to the teaching of documents FR 2 885 633 or FR 2 991 198.

The support thus prepared contains cobalt nitrate impregnated on a support.

The process for the preparation of a Fischer-Tropsch catalyst according to FIG. 1 proposes to carry out stage I of calcining the support impregnated with cobalt in order to obtain a catalyst precursor.

The support impregnated with cobalt is introduced in stage I via the pipe 13 in order to be calcined. The calcining stage I can be carried out in a calciner.

The calcining is carried out by flushing the support impregnated with cobalt with a gas containing oxygen, for example air, at a temperature comprised between 400° C. and 450° C., or even between 410° C. and 450° C. Preferably, the support impregnated with cobalt is brought to the calcining temperature for a duration greater than 2 h, for example comprised between 2 h and 10 h, preferably between 2 h and 5 h. The calcining carried out at high temperature, comprised between 400° C. and 450° C., makes it possible to transform the cobalt nitrate to cobalt oxides, for example to Co₃O₄, to CoO, and thus to decompose all, or practically all, of the nitrate present on the support. Thus, the catalyst precursor obtained at the end of the calcining stage has a reduced oxygen content with respect to the support impregnated with cobalt in the form of nitrate. This makes it possible to minimize the release of water during the reduction stage described below. In fact, when cobalt nitrate and hydrogen are brought into contact, the main products that can form will be CoO or metallic Co, but also water, ammonia, nitrogen oxides and nitrogen.

Before carrying out the calcining stage, it is possible to carry out a stage of drying the support impregnated with cobalt for example at a temperature comprised between 100° C. and 140° C., for a duration of ½ h to 5 h, preferably between 1 h and 4 h.

If the impregnation of cobalt on the catalyst support is carried out in two or more stages, after each impregnation stage a calcining stage can be carried out, and optionally, a drying stage under the conditions described above.

In addition, the catalyst precursor in the form of cobalt oxide has the advantage of being stable, and as a result can be stored and transported as it is, without special precautions.

The calcined catalyst precursor obtained in stage I is introduced into the reduction reactor A via the pipe 10.

The catalyst precursor is batch-fed into the reduction reactor A. The reactor can operate as a fixed catalyst bed. The reduction is carried out by circulating a flow of reducing gas, also called reduction gas, through the catalyst precursor bed. The reduction gas is introduced into the reactor A via the pipe 1, in order to pass through the catalyst precursor bed. Then the reduction gas is removed from the reactor A via the pipe 2. Feeding the catalyst precursor can be carried out so as to obtain a distribution of the grains of catalyst precursor that is as homogeneous as possible. This makes it possible to limit preferred pathways of the reduction gas that are detrimental to the performance of the Fischer-Tropsch catalyst.

A reduction gas is used, introduced into the reduction reactor A, comprising at least 99% by volume of hydrogen, and preferably at least 99.5% by volume of hydrogen, in order to limit the detrimental effects of other chemical elements on the performance of the Fischer-Tropsch catalyst. In particular, the reduction gas introduced into the reduction reactor A comprises a water content of less than 200 ppmvol, preferably less than 100 ppmvol, or even less than 50 ppmvol.

Bringing the catalyst precursor comprising cobalt oxide CO₃O₄ into contact with hydrogen under certain temperature conditions detailed below makes it possible to convert the cobalt oxide CO₃O₄ to metallic cobalt Co°. The conversion of the cobalt oxide to metallic cobalt also generates the production of water. However, the production of water during the reduction of the cobalt is minimized by the absence or very low presence of cobalt nitrates that have been decomposed during the calcining at high temperature.

In addition, according to the invention, the reduction reactor A is operated so as to maintain a water content of less than 10,000 ppmvol, preferably a water content of less than 5,000 ppmvol, or even less than 4,000 ppmvol in the reduction gas circulating in the catalyst precursor bed in the reactor A. For example, the water content in the reduction gas of less than 10,000 ppmvol can be measured in the reduction gas downstream of the reactor A via the pipe 2. According to the invention, in order to limit the water content in the reduction gas to a value less than 10,000 ppmvol, preferably less than 5,000 ppmvol, or even less than 4,000 ppmvol, the support impregnated with cobalt is calcined at a high temperature comprised between 400° C. and 450° C. in order to decompose the nitrate and therefore limit the content of oxygen atoms per cobalt atom of the catalyst precursor, and the operating conditions of the reduction stage in the reactor A are also adapted.

For example, the operating conditions that can be modified in order to maintain the water content in the reduction gas at less than 10,000 ppmvol, preferably less than 5,000 ppmvol, or even less than 4,000 ppmvol, for the reduction stage are:
The flow rate of the reduction gas.
The pressure in the reactor A.
The temperature in the reactor A, in particular defined by at least one of the following parameters: the temperature gradient, the temperature plateau and the reduction temperature.
The duration of the reduction stage.
The internal volume of the reactor A.
The quantity of catalyst precursor in the reactor A.

Generally, the flow rate of hydrogen 1 required for optimum reduction of the catalyst precursor can be comprised between 1 Nm³/h/kg of catalyst precursor and 6 Nm³/h/kg of catalyst precursor and preferably between 2 Nm³/h/kg of catalyst precursor and 5 Nm³/h/kg of catalyst precursor. The flow rate of the reduction gas in the reactor A can be increased in order to dilute the water in the reduction gas and therefore reduce the water content in the reduction gas in the reactor A to a content of less than 10,000 ppmvol, preferably less than 5,000 ppmvol, or even less than 4,000 ppmvol.

The reduction of the Fischer-Tropsch catalyst precursor is carried out at a pressure comprised between 0 and 1.5 MPa g (0 bar(g) and 15 bar(g)) and preferably between 0.3 and 1 MPa g (3 bar(g) and 10 bar(g)) and at a final reduction temperature comprised between 350° C. and 500° C. and preferably between 400° C. and 450° C. This final reduction temperature can be reached by increasing the temperature of the reduction gas from, for example a temperature close to ambient temperature up to the final reduction temperature. The temperature gradient can be comprised between 0.5° C./min and 4° C./min and preferably between 0.5° C./min and 3° C./min. During the increase in temperature, it is possible to have a plateau at a constant temperature comprised between 100° C. and 200° C. and preferably between 130° C. and 170° C. This plateau can be for 1 to 5 hours in order to reduce the water content contained in the catalyst. Preferably, a low temperature gradient is selected comprised between 0.5° C./min and 2° C./min so as to reduce the rate of formation of water and therefore to spread the release of water over time during the reduction stage and, as a result, to reduce the water content in the reducing gas in the reactor A to a content of less than 10,000 ppmvol, preferably less than 5,000 ppmvol, or even less than 4,000 ppmvol. The catalyst precursor is maintained at the final reduction temperature for a duration comprised between 2 hours and 30 hours, preferably between 5 hours and 24 hours, or even between 10 hours and 16 hours, for example depending on the quantity of catalyst precursor fed in and the final temperature reached.

Preferably, a final reduction temperature is selected that is less than the calcining temperature. For example, the final reduction temperature is less by at least 5° C., preferably at least 10° C. than the calcining temperature. Thus, the production of water in the reduction reactor will be generated by the reduction phenomenon, and there should not be a nitrate decomposition phenomenon due to the temperature, a decomposition that would generate a water production peak.

Moreover, the quantity of catalyst precursor can be reduced and/or the internal volume of the reactor A can be increased, in order to limit the water content in the reducing gas in the reactor A to a content less than 10,000 ppmvol, preferably less than 5,000 ppmvol, or even less than 4,000 ppmvol.

The catalyst in the reduced form can then be cooled by the flow of reducing gas to a temperature comprised between ambient temperature and 150° C., preferably between 80° C. and 120° C.

The flow of reducing gas arriving via the pipe 1 comprises a quantity of hydrogen in excess with respect to the consumption required for the reduction of the cobalt oxide particles to metallic cobalt. As a result, a fraction of the hydrogen injected via the pipe 1 into the reduction reactor A is not consumed. This fraction is removed from the reactor A via the pipe 2. In addition, the flow of reduction gas removed via the pipe 2 contains the products originating from the reduction reaction, mainly water.

The flow of reducing gas removed via the pipe 2 is firstly cooled through a heat exchanger of the feedstock/effluent type D, then it is introduced via the pipe 3 into a compressor E making it possible to compensate for the pressure drops in the process.

The pressurized gas originating from the compression system E is directed via the pipe 4 to a system for the elimination of water which is detrimental for the reduction of the catalyst, in two stages, a condensation stage F and a drying stage G.

The condensation stage F is carried out in two stages, a first stage of cooling the effluent 4 originating from the compressor E to a temperature comprised between 10° C. and 50° C. and preferably between 20° C. and 40° C. making it possible to condense the aqueous fraction, followed by a stage of separation of the condensed liquid fraction from the gaseous fraction. The first stage of cooling can be carried out by heat exchange with a heat transfer fluid, for example water or air. The cooling makes it possible to condense at least a fraction of the water contained in the effluent arriving via the pipe 4. The second stage of condensation stage F is a separation stage which can be carried out in a flash drum making it possible to collect the condensed water in liquid form at the bottom of the drum and to recover the gaseous fraction rich in hydrogen at the top of the drum. The condensation stage F makes it possible to produce an effluent, removed via the pipe 5, having a dew point comprised between 10° C. and 50° C. and preferably between 20° C. and 40° C.

The effluent 5, still containing some water, originating from the pressure and temperature saturation, is sent to a drying stage G. The drying stage G is preferably carried out by molecular sieves but can also be done by other processes known to a person skilled in the art. When molecular sieves are used, the preferred embodiment utilizes at least two molecular sieves positioned in parallel, one in operation and one in regeneration. By way of example, the molecular sieve used can be a 13× sieve. The drying makes it possible to dry the gas until reaching a dew point of the gas removed via the pipe 6 comprised between 0° C. and −60° C. and preferably between −20° C. and −40° C. The reduction gas removed via the pipe 6 originating from the drying stage G can thus be recycled via the pipes 6, 8, 9 and 1 into the reduction reactor A. The regeneration of the water-rich molecular sieve can be carried out by a flow of hot hydrogen originating from the reduction reactor A via the pipe 14, the water content of which is controlled. The flow of hydrogen that has been used for the regeneration of the sieve can be recycled into the process via the pipe 15, by being introduced into the compression stage E. The regeneration stage is finalized when the water content in the outlet hydrogen 15 has stabilized.

In order to compensate for the pressure drop associated with the hydrogen consumption, a fresh makeup of hydrogen is injected via the pipe 7 into the recirculation loop of the reduction gas arriving via the pipe 6.

The flow 8, composed of a majority of recycled hydrogen arriving via the pipe 6 and a minority of fresh hydrogen arriving via the pipe 7, being at a temperature less than the temperature required for the reduction of the catalyst, is heated for example in two stages. The first stage is carried out through the feedstock/effluent heat exchanger D then in an oven H. The heat exchanger D makes it possible to exchange heat between the reducing gas circulating in the pipe 2 and the reducing gas circulating in the pipe 8. The gas arriving in the exchanger D via the pipe 8 leaves the exchanger again via the pipe 9 to be introduced into the oven H, then is introduced into the reactor A via the pipe 1. The oven H makes it possible to bring the flow of reducing gas to the required temperature for the reduction reaction in the reactor A.

The catalyst in reduced form is removed from the reactor A via the pipe 11 and is then maintained constantly under an atmosphere that is inert or protected from the air until it is introduced into the Fischer-Tropsch synthesis reactor C. The reduced and cooled catalyst can be discharged by gravity from the reduction reactor A to an intermediate container B via the pipe 11. The container B can be filled with a liquid, for example a liquid hydrocarbon such as wax produced by the Fischer-Tropsch reaction and maintained at a temperature, an isoparaffinic solvent with a high boiling point, so as to protect the reduced catalyst from oxidation and thus to maintain the performance of the final catalyst. Then the catalyst is introduced with the liquid into the Fischer-Tropsch reactor C via the pipe 12.

Then the catalyst is brought into contact in the reactor C with a synthesis gas, comprising carbon monoxide and hydrogen in order to produce hydrocarbon-containing compounds according to the Fischer-Tropsch reaction.

The Fischer-Tropsch process allows the production of essentially linear and saturated C5+ hydrocarbons. According to the invention, by hydrocarbons is meant essentially linear and saturated C5+ hydrocarbons, hydrocarbons of which the proportion of hydrocarbon-containing compounds having at least 5 carbon atoms per molecule represents at least 50% by weight, preferably at least 80% by weight of the total of the hydrocarbons formed, the total content of olefinic compounds present among said hydrocarbon-containing compounds having at least 5 carbon atoms per molecule being less than 15% by weight. The hydrocarbons produced by the process of the invention are thus essentially paraffinic hydrocarbons, the fraction of which having the highest boiling points can be converted with a high yield to middle distillates (gas oil and kerosene cuts) by a catalytic hydroconversion process such as hydrocracking and/or hydroisomerization.

Preferably, the feedstock utilized in order to implement the process of the invention is constituted by the synthesis gas, which is a mixture of carbon monoxide and hydrogen having H₂/CO molar ratios that can vary between 0.5 and 4 depending on the production process from which it originates. The H₂/CO molar ratio of the synthesis gas is generally close to 3 when the synthesis gas is obtained from the process of steam reforming of hydrocarbons or of alcohol. The H₂/CO molar ratio of the synthesis gas is of the order of 1.5 to 2 when the synthesis gas is obtained from a partial oxidation process. The H₂/CO molar ratio of the synthesis gas is generally close to 2.5 when it is obtained from an autothermal reforming process. The H₂/CO molar ratio of the synthesis gas is generally close to 1 when it is obtained from a CO₂ gasification and reforming process of hydrocarbons (called dry reforming).

The Fischer-Tropsch process according to the invention is operated under a total pressure comprised between 0.1 and 15 MPa, preferably between 0.5 and 10 MPa, at a temperature comprised between 150 and 350° C., preferably between 180 and 270° C. The hourly volume velocity is advantageously comprised between 100 and 20000 volumes of synthesis gas per volume of catalyst and per hour (100 to 20000 h⁻¹) and preferably between 400 and 10000 volumes of synthesis gas per volume of catalyst and per hour (400 to 10000 h⁻¹).

The Fischer-Tropsch process according to the invention can be carried out in a reactor of the perfectly stirred autoclave type, ebullating bed, bubble tower, fixed bed or moving bed. Preferably, it is carried out in a reactor of the bubble tower type.

To this end, the size of the grains of the catalyst used in the Fischer-Tropsch process can be comprised between a few microns and 2 millimetres. Typically, for utilization in a three-phase “slurry” reactor (in a bubble tower), the catalyst is finely divided and is in the form of particles. The size of the particles of catalyst will be comprised between 10 and 500 micrometres (μm), preferably between 10 and 300 μm and very preferably between 20 and 150 μm, and even more preferably between 20 and 120 μm.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing and in the examples, all temperatures are set forth uncorrected in degrees Celsius and, all parts and percentages are by weight, unless otherwise indicated.

The entire disclosures of all applications, patents and publications, cited herein and of corresponding French application No. 15/57.396 filed Jul. 31, 2015 is incorporated by reference herein.

### EXAMPLES

The calcined and reduced catalyst precursors in the examples presented hereinafter are prepared by carrying out the following stages.

### Reference Example

A Fischer Tropsch catalyst according to the invention is prepared by carrying out the following stages:

A Fischer Tropsch catalyst precursor comprising cobalt deposited on a silica-alumina support is prepared by dry impregnation of an aqueous solution of cobalt nitrate so as to deposit in two successive stages, of the order of 15% by weight of Co on a commercial silica-alumna powder (SIRALOX® 5/170, SASOL).

After a first dry impregnation, the solid is dried in an oven at 110° C. for 3 h, then calcined at a calcining temperature of 430° C. for 4 h in a furnace. The intermediate catalyst contains approximately 8% by weight of Co. It is subjected to a second stage of dry impregnation using an aqueous solution of cobalt nitrate. The solid obtained is dried in an oven at 110° C. for 3 h then calcined at a calcining temperature of 430° C. for 4 h in a furnace. A catalyst precursor is obtained that contains 15% by weight of Co.

This catalyst precursor is used in all of the examples presented hereinafter, with the exception of Example 5, in which the calcining temperature was changed.

The catalyst precursor is then reduced in a fixed-bed reactor. The reducing gas constituted by hydrogen and comprising less than 100 ppmvol of water is introduced into the reactor at ambient temperature, then the temperature is brought to a value of 150° C., following a temperature gradient of 1° C./min under a gas hourly space velocity (GHSV) of 4 Nl/h/g of catalyst. The temperature of 150° C. is maintained for 3 h, then it is brought to a temperature of 410° C. with a temperature gradient of 1° C./min under a GHSV of hydrogen of 3 Nl/h/g of catalyst. This temperature is maintained for 20 h.

The water content in the reduction reactor is maintained at a content of approximately 7000 ppmvol. Then the reducing gas is recycled, following the stages of the process according to FIG. 1, into the reduction reactor.

Then, the rate of reduction of the catalyst obtained is measured.

The rate of reduction is calculated on the basis of the analysis results of TPR (temperature programmed reduction) of a reduced solid and of a passivated solid oxide, recovered at the end of the hydrogen chemisorption, by the following formula:

$$Rate of reduction = ( \frac{\% Co\_reduced}{\% Co\_total} ) \times ( 1 - \frac{V 2 - V 3}{0.75 \times V 1} ) \times 100$$

with

$$\% Co\_reduced = \frac{0.75 \times V 1 \times 58.93}{22400} \times 100$$

$$\% Co\_total is measured by X \text{-} ray fluorescence$$

V1: the total volume of hydrogen consumed during the oxide catalyst TPR [Nml/g]
V2: the total volume of hydrogen consumed during the reduced catalyst TPR [Nml/g]
V3: the volume of hydrogen consumed by the passivated cobalt fraction [Nml/g] (volume of hydrogen consumed during the reduced catalyst TPR up to a default value of 500° C.)

The temperature programmed reduction (TPR) such as described for example in Oil & Gas Science and Technology, Rev. IFP, Vol. 64 (2009), No. 1, pp. 11-12. According to this technique, the catalyst is heated under a flow of hydrogen.

### Example 1

In this example, the cobalt-based Fischer-Tropsch catalyst precursor of the reference example is reduced with a reducing gas comprising a water content of 2% vol in hydrogen. The composition of the reduction gas in Example 1 varies: the reduction gas contains 98% by volume of hydrogen and 2% by volume of water.

Increasing the water content of the reduction gas has the effect of drastically reducing the rate of reduction. The catalytic performance of the catalyst utilized in a Fischer-Tropsch synthesis will thereby deteriorate with respect to the reference catalyst prepared according to the described invention.

| | | Reference | Example 1 |
|---|---|---|---|
| Reducing gas | [—] | Hydrogen | Hydrogen |
| Water content | [% vol] | 0.01 | 2 |
| Rate of reduction | [—] | 1 | 0.2 |

### Example 2

In this further example, the gas used for the reduction of the cobalt-based Fischer-Tropsch catalyst precursor of the reference example is not pure hydrogen but a mixture of hydrogen and nitrogen. The reduction gas contains 20% by volume of nitrogen and 80% by volume of hydrogen.

The increase in the nitrogen content in the reduction gas has the effect of reducing the rate of reduction of the catalyst. The catalytic performance of the catalyst utilized in a Fischer-Tropsch synthesis deteriorates as a result with respect to the reference catalyst prepared according to the described invention.

| | | Reference | Example 2 |
|---|---|---|---|
| Reducing gas | [—] | Hydrogen | Hydrogen and |
| | | | nitrogen |
| Nitrogen content | [% vol] | 0 | 20 |
| Rate of reduction | [—] | 1 | 0.8 |

### Examples 3 and 4

In these further examples, the duration of the reduction stage was reduced. In Example 3, the duration of maintenance at the final reduction temperature is reduced by half, i.e. 10 hours, and in Example 4, the duration of the plateau is reduced by 90%, i.e. to 2 hours.

The reduction of the holding duration at the final reduction temperature has the effect of reducing the rate of reduction of the catalyst. The catalytic performance of the catalyst utilized in a Fischer-Tropsch synthesis deteriorates as a result with respect to the reference catalyst prepared according to the described invention.

| | | Reference | Example 3 | Example 4 |
|---|---|---|---|---|
| Reducing gas | [—] | Hydrogen | Hydrogen | Hydrogen |
| Duration of the plateau | [—] | 1 | 0.5 | 0.1 |
| Rate of reduction | [—] | 1 | 0.8 | 0.5 |

### Example 5

In this further example, the same preparation protocol is used for the preparation of the catalyst as for the reference example, with the exception of the calcining temperature, which was reduced to 350° C.

Lowering the calcining temperature has the effect of reducing the rate of reduction of the catalyst. The catalytic performance of the catalyst utilized in a Fischer-Tropsch synthesis deteriorates as a result with respect to the reference catalyst prepared according to the described invention.

| | | Reference | Example 5 |
|---|---|---|---|
| Reducing gas | [—] | Hydrogen | Hydrogen |
| T Calcining | [° C.] | 430° C. | 350° C. |
| Water content in the | [ppmvol] | 7000 | 13500 |
| reduction gas | | | |
| removed from the | | | |
| reactor | | | |
| Rate of reduction | [—] | 1 | 0.95 |

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

1. Process for the preparation of a catalyst intended for utilization in a Fischer-Tropsch reaction, in which the following successive stages are carried out:
a) A support impregnated with a solution of cobalt nitrate is provided,
b) said support impregnated with a cobalt nitrate solution is oxidized at a calcining temperature comprised between 400° C. and 450° C. in order to produce a catalyst precursor comprising cobalt oxides,
c) a reducing gas is provided, comprising at least 99% by volume of hydrogen and less than 200 ppmvol of water,
d) said catalyst precursor is brought into contact with the reducing gas by circulating the flow of reducing gas over a bed of said catalyst precursor, so as to reduce the cobalt oxides to metallic cobalt in order to produce a reduced catalyst and a flow of reducing gas laden with water,
e) the water content of the flow of reducing gas laden with water recovered in stage d) is reduced, so as to produce a flow of reducing gas comprising less than 200 ppmvol of water, then
f) at least a part of the flow of reducing gas is recycled to stage d),
process in which in staged) the reducing gas is maintained at a water content of less than 10,000 ppmvol.

2. Process according to claim 1 in which, in stage d), the flow rate of reducing gas is comprised between 1 Nm³/h/kg of catalyst precursor and 6 Nm³/h/kg of catalyst precursor and preferably between 2 Nm³/h/kg of catalyst precursor and 5 Nm³/h/kg of catalyst precursor.

3. Process according to claim 1, in which stage d) is carried out at a pressure comprised between 0 and 1.5 MPa g, preferably between 0.3 and 1 MPa g and at a final reduction temperature comprised between 350° C. and 500° C. and preferably between 400° C. and 450° C.

4. Process according to claim 3, in which stage d) is carried out at a final reduction temperature less than the calcining temperature.

5. Process according to claim 3, in which in stage d), the temperature of the reducing gas is progressively increased, according to a temperature gradient comprised between 0.5° C./min and 4° C./min, preferably between 0.5° C./min and 3° C./min, or even between 0.5° C./min and 2° C./min.

6. Process according to claim 1, in which in stage b), the impregnated support is maintained at the calcining temperature for a duration greater than 2 h, preferably comprised between 2 h and 10 h.

7. Process according to claim 1, in which in stage e), a cooling of the reducing gas is carried out, and water condensed by the cooling is eliminated.

8. Process according to claim 7, in which in stage e), moreover, the reducing gas is brought into contact with at least one molecular sieve which captures the water.

9. Process according to claim 8, in which the molecular sieve is regenerated by bringing the molecular sieve into contact with a portion of the flow of water-laden reducing gas recovered in stage d), said portion then being introduced with the reducing gas at the inlet of stage e).

10. Process according to claim 1, in which in stage d), the catalyst precursor is maintained at a final reduction temperature for a duration comprised between 5 hours and 24 hours.

11. Process according to claim 1, in which, when at least a part of the cobalt oxides are reduced to metallic cobalt, the reduced catalyst is removed from stage d).

12. Process according to claim 1, in which the support is a porous support having a specific surface area comprised between 100 m²/g and 500 m²/g, preferably between 150 m²/g and 300 m²/g and a pore volume measured by mercury porosimetry comprised between 0.4 ml/g and 1.2 ml/g.

13. Process according to claim 1, in which the support is selected from the supports composed of alumina, a mixture of silica and alumina, silica, titanium oxide, zinc oxide.

14. Catalyst prepared according to claim 1.

15. Process for the production of hydrocarbon compounds, in which the catalyst according to claim 14, is brought into contact with a gaseous mixture of hydrogen and carbon monoxide.
